(19) United States
(12) Patent Application Publication
(10) Pub. No.: US 2020/0382223 A1
(43) Pub. Date: Dec. 3, 2020

(54) USER DEVICE FOR ACQUIRING LIFE LOG INFORMATION OF USER BASED ON TOUCH, EDGE DEVICE FOR GENERATING SERVICE INFORMATION BASED ON LIFE LOG INFORMATION ACQUIRED THEREBY, AND HUMAN BODY COMMUNICATION SYSTEM INCLUDING USER DEVICE AND EDGE DEVICE

(71) Applicant: ELECTRONICS AND TELECOMMUNICATIONS RESEARCH INSTITUTE, Daejeon (KR)

(72) Inventors: Hyuk KIM, Daejeon (KR); Hyung-IL PARK, Daejeon (KR); Tae Wook KANG, Daejeon (KR); Sung Eun KIM, Daejeon (KR); Mi Jeong PARK, Sejong-si (KR); Kyung Jin BYUN, Daejeon (KR); Kwang IL OH, Daejeon (KR); Jae-Jin LEE, Daejeon (KR); In Gi LIM, Daejeon (KR)

(73) Assignee: ELECTRONICS AND TELECOMMUNICATIONS RESEARCH INSTITUTE, Daejeon (KR)

(21) Appl. No.: 16/881,657

(22) Filed: May 22, 2020

(30) Foreign Application Priority Data
May 29, 2019 (KR) 10-2019-0063120

(51) Int. Cl. H04B 13/00; G06F 16/9535; G06F 3/044; H04B 5/00

(52) U.S. Cl. CPC H04B 13/005; H04B 5/0031; G06F 3/044; G06F 16/9535

(57) ABSTRACT

A user device connected to an edge device, based on a touch of a user includes an electrode in touch with a body of the user, a human body communication module that receives a first signal from the edge device through the body and the electrode, an operation processing module that acquires identification information, location information, version information of the edge device, and time information at which the first signal is received, from the first signal, and a memory module that stores the identification information, the location information, the version information, and the time information, as part of life log information.

### CROSS-REFERENCE TO RELATED APPLICATIONS

This U.S. non-provisional patent application claims priority under 35 U.S.C. § 119 of Korean Patent Application No. 10-2019-0063120, filed on May 29, 2019, the entire contents of which are hereby incorporated by reference.

### BACKGROUND

Embodiments of the inventive concept relate to a technology for acquiring life log information, and more particularly, relate to a user device for acquiring life log information of a user based on a touch, an edge device for generating service information based on the life log information acquired by the user device, and a human body communication system including the user device and the edge device.

As information and communication technology (ICT) develops rapidly, not only in hospitals, banks and airports, but also in fast food stores, kiosk-based services equipped with large touch panels are increasing. As a result, preferences of modern people who are reluctant to expose personal information are technically reflected, but a complexity of using the services are increased. Therefore, a change is needed such that an easy and simple user interface/user experience (UI/UX) may be provided to a user.

### SUMMARY

Embodiments according to the inventive concept provide a user device for acquiring life log information of a user based on a touch, an edge device for generating service information based on the life log information acquired by the user device, and a human body communication system including the user device and the edge device.

According to an embodiment of the inventive concept, a user device connected to an edge device, based on a touch of a user includes an electrode in touch with a body of the user, a human body communication module that receives a first signal from the edge device through the body and the electrode, an operation processing module that acquires identification information, location information, version information of the edge device, and time information at which the first signal is received, from the first signal, and a memory module that stores the identification information, the location information, the version information, and the time information, as part of life log information.

According to another embodiment of the inventive concept, an edge device connected to a user device, based on a touch of a user includes an electrode in touch with a body of the user, an operation processing module that generates a first signal including identification information, version information, and location information, and a human body communication module that transmits the first signal to the user device through the electrode and the body, and receives a second signal including life log information stored in the user device from the user device through the body and the electrode. The operation processing module generates a plurality of service information, based on the second signal.

According to another embodiment of the inventive concept, a human body communication system to communicate using a body of a user as a medium includes an edge device that generates a first signal including identification information, location information, and version information, and a user device that receives the first signal through the body of the user, acquires the identification information, the location information, the version information, and time information at which the first signal is received, from the first signal, and stores the identification information, the location information, the version information, and the time information, as part of life log information.

### BRIEF DESCRIPTION OF THE FIGURES

The above and other objects and features of the inventive concept will become apparent by describing in detail exemplary embodiments thereof with reference to the accompanying drawings.

FIG. 1 is a diagram illustrating a human body communication system according to an embodiment of the inventive concept.

FIG. 2 is a block diagram illustrating a user device of FIG. 1.

FIG. 3 is a block diagram illustrating an edge device communicating in one direction with a user device, according to an embodiment of the inventive concept.

FIG. 4 is a flowchart describing an operation of a user device communicating in one direction with an edge device of FIG. 3.

FIG. 5 is a diagram illustrating device information of an edge device according to an embodiment of the inventive concept.

FIG. 6 is a diagram illustrating device information of an edge device according to another embodiment of the inventive concept.

FIG. 7 is a block diagram illustrating an edge device communicating in both directions with a user device, according to an embodiment of the inventive concept.

FIG. 8 is a block diagram illustrating a front portion of an edge device of FIG. 7.

FIGS. 9 to 11 are flowcharts describing an operation of a user device communicating in both directions with an edge device of FIG. 7.

FIG. 12 is a diagram illustrating query information of FIGS. 8 and 9, according to an embodiment of the inventive concept.

FIG. 13 is a diagram illustrating response information of a user to query information of FIG. 12.

FIG. 14 is a diagram illustrating a human body communication system according to another embodiment of the inventive concept.

### DETAILED DESCRIPTION

Hereinafter, embodiments of the inventive concept will be described clearly and in detail such that those skilled in the art may easily carry out the inventive concept.

In the following drawings or the detailed description, modules may be connected to others in addition to the components illustrated in drawing or described in the detailed description. The modules or components may be directly or indirectly connected. The modules or components may be communicatively connected or may be physically connected.

Components described with reference to terms such as a part, a unit, a module, or a layer used in the detailed description may be implemented in the form of software, a hardware, or a combination thereof. Illustratively, the software may be machine code, a firmware, embedded code, and application software. For example, the hardware may include an electrical circuit, an electronic circuits, a processor, a computer, integrated circuit cores, a pressure sensor, an inertial sensor, a micro electro mechanical system (MEMS), a passive element, or a combination thereof.

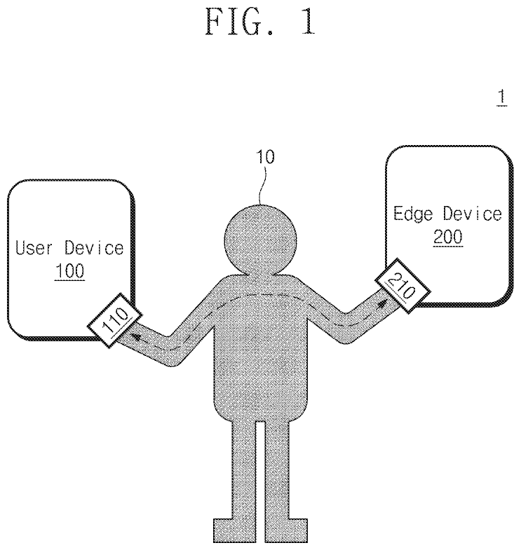

FIG. 1 is a diagram illustrating a human body communication system according to an embodiment of the inventive concept. A human body communication system 1 may be a system that communicates through a body 10 of a user as a medium. The human body communication system 1 may include a user device 100 and an edge device 200. The user device 100 may include an electrode 110 in touch with the body 10 of the user. The edge device 200 may include an electrode 210 in touch with the body 10 of the user.

The user device 100 may communicate with the edge device 200 by using a human body communication. The user device 100 may communicate with the edge device 200 through the electrodes 110 and 210 and the body 10 of the user. The user device 100 may provide information to the user, based on a signal received from the edge device 200.

The human body communication is a technology that transmits data using a conductive human body as a communication channel. By means of the human body communication, various information devices close to the human body may communicate through the human body. The human body communication technology may include a capacitive coupling method and a galvanic coupling method. The galvanic coupling method is a method of transmitting a signal through a signal electrode and a ground electrode that form a pair and are touched with the human body. The galvanic coupling method is suitable for stably transmitting a signal to a place at a relatively short distance. The capacitive coupling method is a method in which the ground electrode is kept open and the signal is transmitted by touching only the signal electrode to the human body. The capacitive coupling method requires a separate virtual ground plane. According to the capacitive coupling method, the signal may be transmitted to a place that is relatively far away.

Although exemplary configurations and operations in which the user device 100 communicates with the edge device 200 through the body 10 of the user will be described, it will be understood that the user device 100 may communicate with the edge device 200 through various media. As an example, the medium for human body communication may be changed and modified with various living bodies such as animals and plants.

The user device 100 may acquire life log information. Here, the life log literally includes not only records of an individual's daily life, but also records of conscious and unconscious everyday life created by individuals, based on technology. That is, the life log information means records of experiences in the user's life such as events, locations, photos, videos, exercise, health, sleep, SNS information, etc. that are generated from the user in everyday life. The life log information that is produced in large quantities needs proper management to filter information that is less accurate.

Meanwhile, a touch is an action representing the user's interest or intention, and acquiring the life log information by the user device 100 depending on the touch is the best way to collect identification or use-related information about the object touched by the user in everyday life. For example, when the user uses an object, such as a home appliance, the user may touch the object. The user device 100 may collect information related to whether the object is used, how many times the object is used, how long the object is used, the distance the user is moved to the location of the object, a route, an amount of activity of the user, etc. through a touch-based human body communication from an intuitive action of the user touching the object. A wireless communication such as an RFID (Radio-Frequency Identification) or a NFC (Near Field Communication) requires an intentional close contact between a tag and a receiver, whereas the human body communication method enables accurate data collection reflecting the user's intention in natural daily activities.

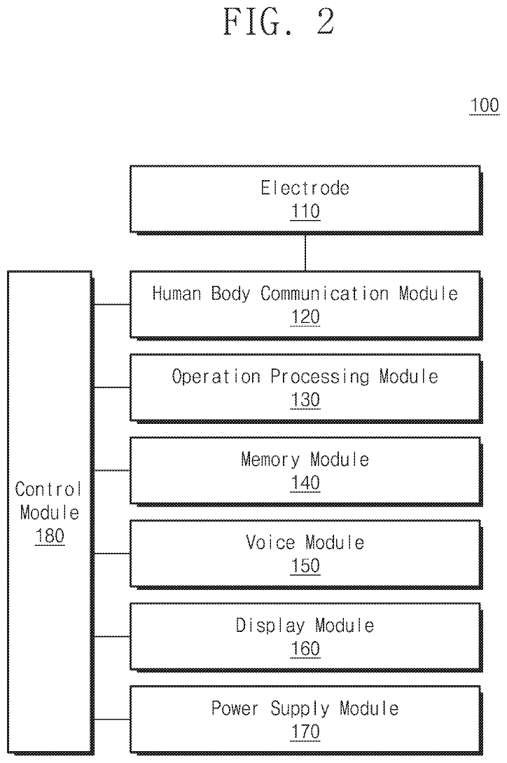

The user device 100 may be a portable terminal such as a smart phone, a smart watch, a wearable device, a personal computer (PC), a workstation, a notebook computer, a PDA, a walkie-talkie, etc. The detailed configuration of the user device 100 will be described in more detail in FIG. 2.

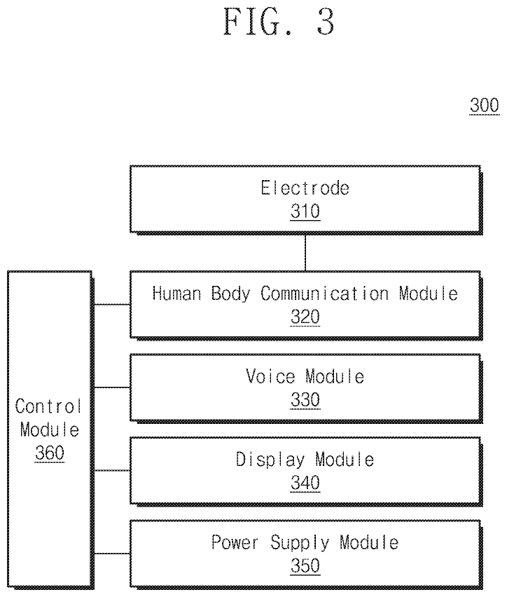

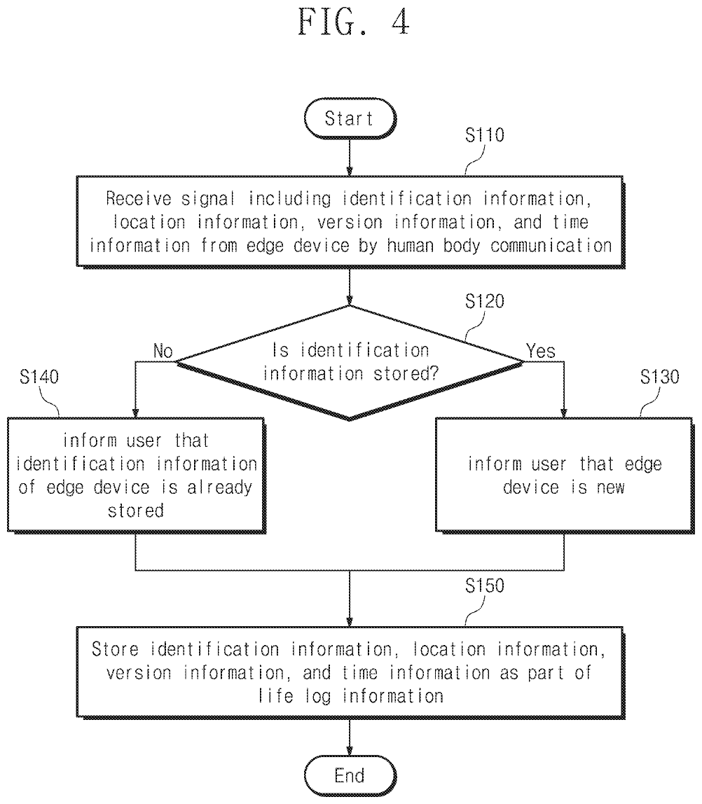

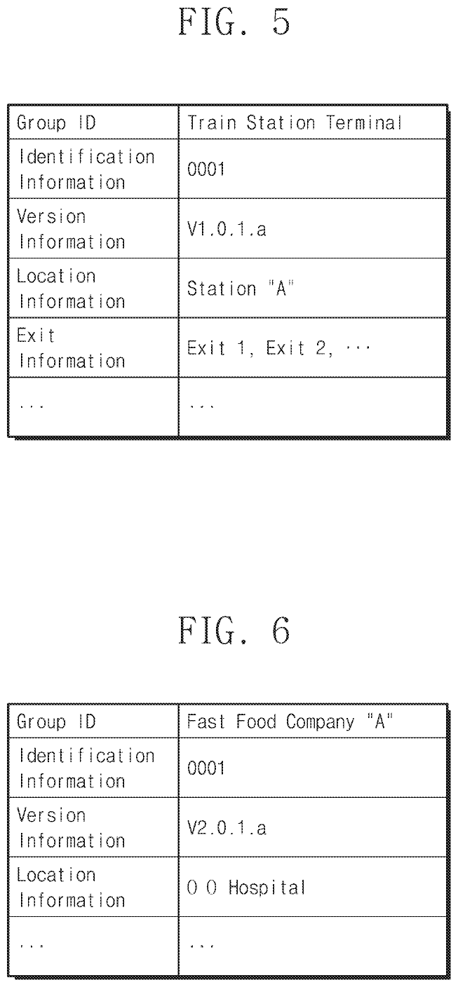

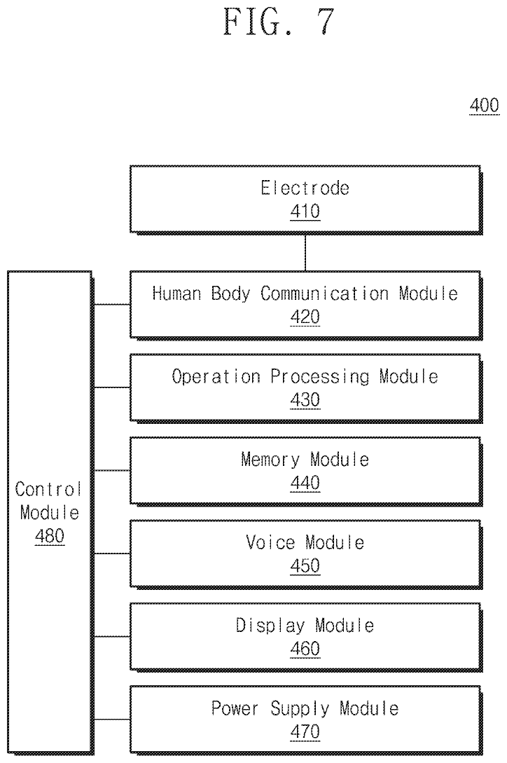

The edge device 200 may provide service information to the user device 100 by using the human body communication. The edge device 200 may communicate with the user device 100 through the electrodes 110 and 210 and the body 10 of the user. In an embodiment, the edge device 200 may be a unidirectional communication device that provides device information only. In this case, the edge device 200 does not receive a signal and information from the user device 100. Here, the device information may include identification information, version information, and location information of the edge device 200. The identification information may be unique information that distinguishes the edge device 200 from other edge devices. The version information may be information indicating whether a performance, service information, etc. of the edge device 200 is updated compared to the past. The location information may be information indicating a location where the edge device 200 is located. The device information may further include more various information (e.g., a group ID in FIGS. 5 and 6) as well as the identification information, the version information, and the location information. The device information of the edge device 200 will be described in more detail with embodiments in FIGS. 5 and 6. An embodiment in which the edge device 200 is the unidirectional communication device will be described in more detail in FIGS. 3 and 4.

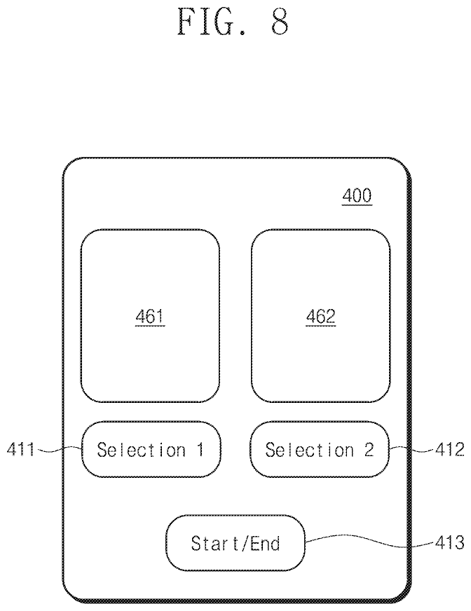

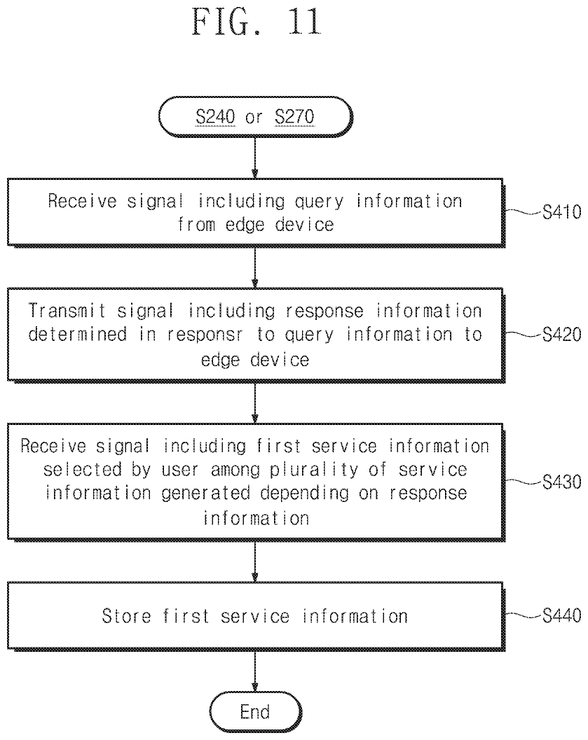

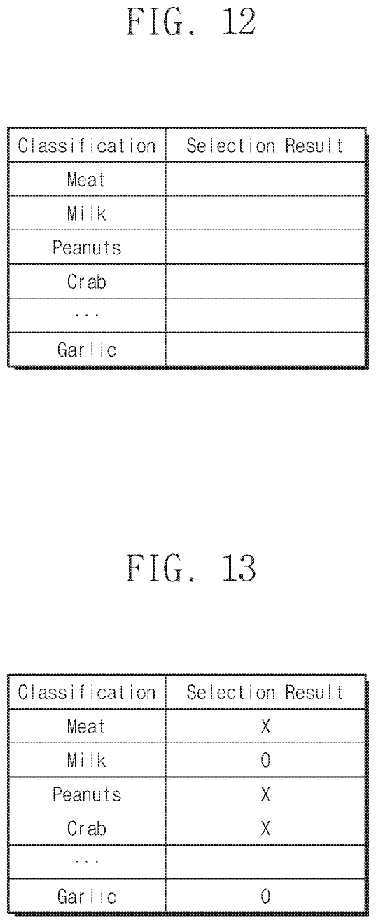

In another embodiment, the edge device 200 may be a bidirectional communication device that provides the device information and query information to the user device 100 and receives response information of the user. Here, the query information may include a query used to analyze service information for recommending to the user. The response information may refer to information including a user's response to the query. The edge device 200 may generate a plurality of services, based on the response information or provide at least one service information among the plurality of service information to the user device 100. The query information and edge information will be described in more detail with embodiments in FIGS. 12 and 13. An embodiment in which the edge device 200 is a bidirectional communication device will be described in more detail in FIGS. 7 and 13.

The edge device 200 may be implemented in various forms, such as a kiosk, a location-fixed type, a wall mount type, etc. The detailed configuration of the edge device 200 will be described in more detail in FIGS. 3 and 7.

FIG. 2 is a block diagram illustrating a user device of FIG. 1. FIG. 2 will be described with reference to FIG. 1. The user device 100 may include the electrode 110, a human body communication module 120, an operation processing module 130, a memory module 140, a voice module 150, a display module 160, a power supply module 170, and a control module 180.

The human body communication module 120 may be directly connected to the electrode 110. The human body communication module 120 may transmit the signal to the edge device 200 through the electrode 110 and the body 10 of the user and may receive a signal from the edge device 200. The human body communication module 120 may operate depending on at least one of the capacitive method and the galvanic method described in FIG. 1.

The operation processing module 130 may process information and data. The operation processing module 130 may include one processor core (Single Core), or multiple processor cores (Multi-Cores) (e.g., dual-core, quad-core, hexa-core, etc.). For example, the operation processing module 130 may include dedicated circuits (e.g., a Field Programmable Gate Arrays (FPGAs), an Application Specific Integrated Circuits (ASICs), etc.) including one or more processor cores, or a System on Chip (SoC). As an example, the operation processing module 130 may further include a cache memory located inside or outside.

The memory module 140 may store information and data. The memory module 140 may include a volatile memory such as a static random access memory (SRAM), a dynamic RAM (DRAM), a synchronous memory (SDRAM), etc. and/or a non-volatile memory such as a flash memory, a phase-change RAM (PRAM), a magneto-resistive RAM (MRAM).), a ReRAM (Resistive RAM), an FRAM (Ferro-electric RAM), etc. Alternatively, the memory module 140 may include a removable memory such as a hard disk drive (HDD), a solid state drive (SSD), a secure digital (SD) card, and/or an embedded memory such as an embedded multimedia card (eMMC), etc.

The voice module 150 may output sound and may receive an electrical signal by converting the sound into the electrical signal. The voice module 150 may output sound including information provided from the operation processing module 130 and provide the electrical signal converted from the sound to the operation processing module 130. The voice module 150 may be implemented in various forms including a speaker and a microphone.

The display module 160 may output at least one of an image and a video. The display module 160 may output at least one of the image and a video including information provided from the operation processing module 130. Also, the display module 160 may include a touch-based input device including a piezoelectric method and an electrostatic method. That is, the display module 160 may receive information from the user while providing the image and the video. The display module 160 may be implemented as a thin film transistor-liquid crystal display (TFT-LCD), a light emitting diode (LED) panel, an organic LED (OLED) panel, or an active-matrix OLED (AMOLED) panel, etc.

The power supply module 170 may supply power to each of components in the user device 100. The power supply module 170 may be implemented with various power devices, such as a built-in battery, a portable battery, or a device that receives power from external.

The control module 180 may be connected to the human body communication module 120, the operation processing module 130, the memory module 140, the voice module 150, the display module 160, and the power supply module 170, respectively. The control module 180 may transfer signals, information, and data between respective components in the user device 100. The control module 180 may be implemented by a dedicated circuit, or may be implemented by the SoC. For example, the control module 180 may include a general purpose processor, a dedicated processor, or an application processor (AP). The control module 180 may be a processor itself or an electronic device or system including a processor.

The configurations of the user device 100 in FIG. 2 are one example, and the user device 100 is not limited thereto. That is, other components may be added to the user device 100 in addition to the components of FIG. 2, or at least one of the components of FIG. 2 may not be included.

FIG. 3 is a block diagram illustrating an edge device communicating in one direction with a user device, according to an embodiment of the inventive concept. An edge device 300 may include an electrode 310, a human body communication module 320, a voice module 330, a display module 340, a power supply module 350, and a control module 360. The edge device 300 may be the edge device 100 of FIG. 1.

The electrode 310, the human body communication module 320, the voice module 330, the display module 340, the power supply module 350, and the control module 360 may have structures that are substantially the same as or similar to the electrode 110, the human body communication module 120, the voice module 150, the display module 160, the power supply module 170, and the control module 180 in the user device 100 of FIG. 2, respectively, and may be implemented with the same principle.

The edge device 300 may communicate with the user device 100 in one direction. When the user touches at the edge device 300, the edge device 300 may provide the device information including the identification information, the version information, and the location information to the user device 100 by using the human body communication. However, the edge device 300 may not receive a signal, information, and data from the user device 100. An operation of the user device 100 in communication with the edge device 300 of FIG. 3 will be described in more detail in FIG. 4.

The configurations of the edge device 300 in FIG. 3 is one example, and the edge device 300 is not necessarily limited thereto. That is, other components may be added to the edge device 300 in addition to the components of FIG. 3 or at least one of the components of FIG. 3 may not be included.

FIG. 4 is a flowchart describing an operation of a user device communicating in one direction with an edge device of FIG. 3. The operation of FIG. 4 will be described with reference to FIGS. 1 to 3.

In operation S110, the user may be in touch with the electrode 110 of the user device 100 and at the same time may touch the electrode 310 of the edge device 300. The edge device 300 may transmit the signal including the identification information, the version information, and the location information of the edge device 300 to the user device 100 through the electrodes 110 and 310 and the body 10 of the user. The human body communication module 120 of the user device 100 may receive the signal including the identification information, the version information, and the location information of the edge device 300 from the edge device 300 through the body 10 of the user and the electrodes 110 and 310.

In operation S120, the operation processing module 130, before the signal including the identification information, the location information, the version information, and the time information is received, may determine whether the identification information of the edge device 300 is stored in the memory module 140. When the identification information of the edge device 300 is stored in the memory module 140 before the signal including the identification information, the location information, the version information, and time information is received, operation S130 may be performed. When the identification information of the edge device 300 is not stored in the memory module 140 before the signal including the identification information, the location information, the version information, and time information is received, operation S140 may be performed.

In operation S140, the user device 100 may inform the user that the edge device 300 is new. In this case, the user device 100 may use at least one of the voice module 150 and the display module 160. When the user device 100 uses the voice module 150, a voice indicating that the edge device 300 is new may be output from the voice module 150. When the user device 100 uses the display module 160, the display module 160 may output an image or a video indicating that the edge device 300 is new.

In operation S130, the user device 100 may inform the user that the identification information of the edge device 300 is already stored in the memory module 140. In this case, the user device 100 may use at least one of the voice module 150 and the display module 160. When the user device 100 uses the voice module 150, a sound indicating that identification information of the edge device 300 is already stored in the memory module 140 may be output from the voice module 150. When the user device 100 uses the display module 160 the display module 160 may output an image or a video indicating that the identification information of the edge device 300 is already stored in the memory module 140.

In operation S150, the memory module 140 may store the identification information, the version information, the location information, and time information of the edge device 300 as part of the life log information.

FIG. 5 is a diagram illustrating device information of an edge device according to an embodiment of the inventive concept. FIG. 5 will be described with reference to FIGS. 1 to 4. In FIG. 5, according to an embodiment, the edge device 300 is assumed to be installed in a train station “A”. The device information of the edge device 300 may include a group ID, the identification information, the version information, the location information, exit information, etc.

The group ID may indicate a group to which the edge device 300 belongs. The group ID may indicate that the edge device 300 is a device (train station terminal) installed at the train station “A”. At least one edge device having the same group ID as the edge device 300 may be present. Any edge device installed at a train station “B” that is distinct from the train station “A” may have the same group ID as the edge device 300.

The identification information may be unique information that distinguishes the edge device 300 from other edge devices installed at the train station “A” or other edge devices installed at other train stations. For example, the identification information of the edge device 300 is “0001”, identification information of another edge device installed at the train station “A” may be different from “0001” (e.g., “0002”). The user device 100 may distinguish the edge device 300 from other edge devices installed at the train station “A” depending on the identification information.

The version information may be information indicating whether an operating performance of the edge device 300 is updated compared to the past. In FIG. 5, the version information of the edge device 300 is V1. 0. 1. A. For example, when the performance of the edge device 300 is improved, the version information of the edge device 300 may be updated as V1. 0. 1. b, V1. 0. 2. a, V1. 1. 1. a, or V2. 0. 1. a.

The location information may be information indicating that the edge device 300 is located at the train station “A”. Unlike FIG. 5, the location information may indicate that the edge device 300 is located at a specific place in the train station “A”. For example, the location information may indicate that the edge device 300 is located in front of the rest room in the train station “A”.

The exit information is information associated with a plurality of exits of the train station “A”. The user device 100 may receive the signal including the device information of FIG. 5, and may provide the user with information associated with the plurality of exits of the train station “A”, based on the exit information of the device information.

FIG. 6 is a diagram illustrating device information of an edge device according to another embodiment of the inventive concept. FIG. 6 will be described with reference to FIGS. 1 to 5. In FIG. 6, according to another embodiment, the edge device 300 is assumed to be installed in a fast food restaurant “A” in an OO hospital. The device information of the edge device 300 may include the group ID, the identification information, the version information, the location information, etc.

The group ID may indicate that the edge device 300 is a device installed in the fast food restaurant “A”. Any edge device installed in the fast food restaurant “A” in a XX hospital, which is distinguished from the fast food restaurant “A” in the OO hospital, may have the same group ID as the edge device 300. However, since the group ID according to the embodiment of FIG. 5 is different from the group ID according to the embodiment of FIG. 6, the user device 100 may determine that both groups are different, based on each device information.

The identification information may be unique information that distinguishes the edge device 300 from other edge devices installed in the fast food restaurant “A” in the OO hospital or other edge devices installed in other restaurants. The user device 100 may distinguish the edge device 300 from other edge devices installed in the fast food restaurant “A” in the OO hospital depending on the identification information.

In FIG. 6, the version information is V2. 1. A. The user device 100 may determine that the edge device 300 is updated through the version information of the device information.

The location information may be information indicating that the edge device 300 is located at the OO hospital. When the user device 100 stores the location information of device information according to an embodiment of FIG. 5 and the location information of device information according to an embodiment of FIG. 6 as the life log information, the user device 100 may generate information about a route the user moves, based on the life log information.

FIG. 7 is a block diagram illustrating an edge device communicating in both directions with a user device, according to an embodiment of the inventive concept. An edge device 400 may include an electrode 410, a human body communication module 420, an operation processing module 430, a memory module 440, a voice module 450, a display module 460, a power supply module 470, and a control module 480. The edge device 400 may be the edge device 200 of FIG. 1.

The electrode 410, the human body communication module 420, the operation processing module 430, the memory module 440, the voice module 450, the display module 460, the power supply module 470, and the control module 480 may have structures that are substantially the same as or similar to the electrode 110, the human body communication module 120, the operation processing module 130, the memory module 140, the voice module 150, the display module 160, the power supply module 170, and the control module 180 in the user device 100 of FIG. 2, respectively, and may be implemented with the same principle.

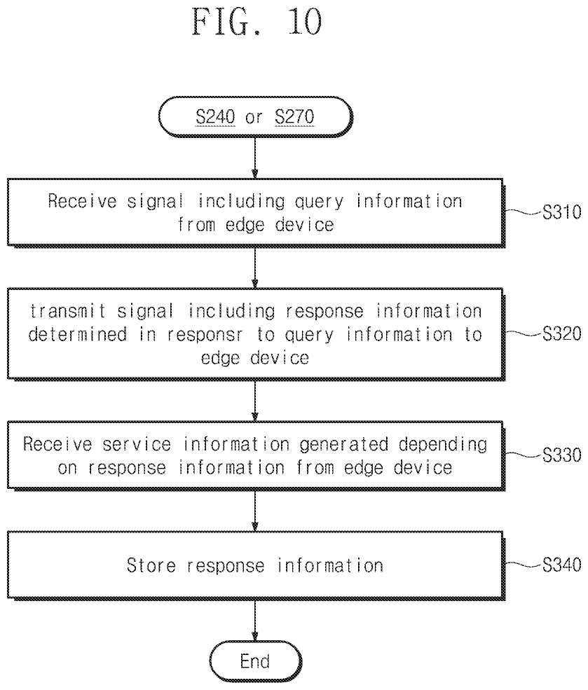

When the user touches the electrode 410, the edge device 400 may transmit a simple query for providing a service to the user device 100, using the human body communication. The edge device 400 may receive response information to the query from the user device 100. The edge device 400 may organize services provided to suit the user's preferences, and may provide customized services optimized to the user by transmitting the results to the user. An operation of the user device 100 communicating with the edge device 400 of FIG. 7 will be described in more detail in FIGS. 9 to 11.

The configuration of the edge device 400 in FIG. 7 is one example, and the edge device 400 is not necessarily limited thereto. That is, other components may be added to the edge device 400 in addition to the components of FIG. 7 or at least one of the components of FIG. 7 may not be included.

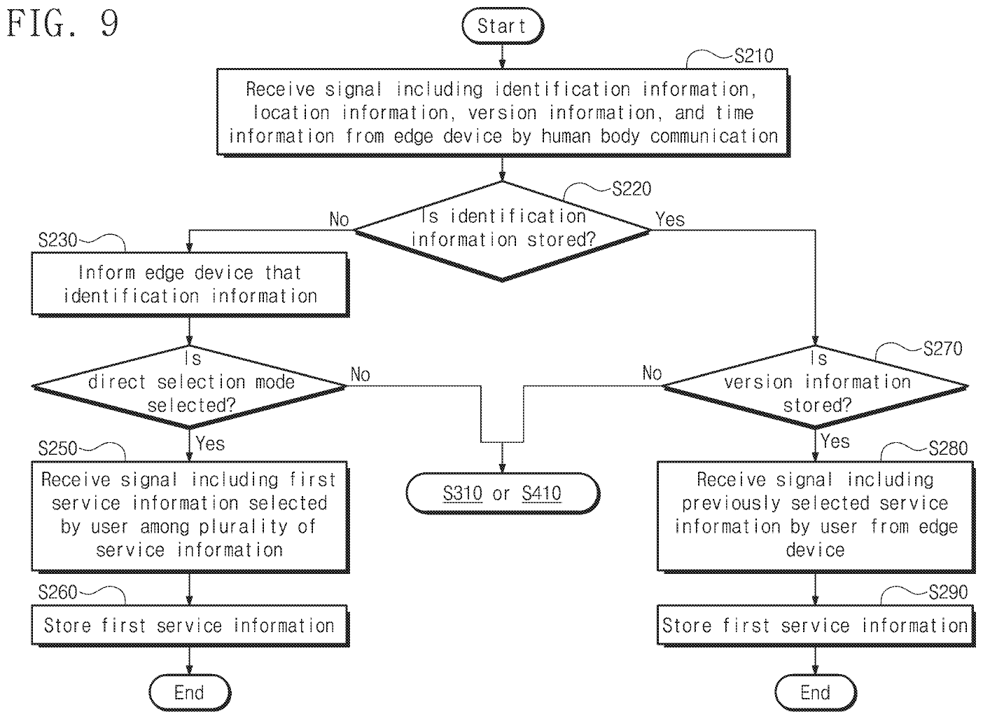

FIG. 8 is a block diagram illustrating a front portion of an edge device of FIG. 7. FIG. 8 will be described with reference to FIGS. 1, 2, and 7. In FIG. 8, the edge device 400 may include first and second display units 461 and 462 included in the display module 460, and first to third electrodes 411 to 413 connected to the human body communication module 420. Except for the components illustrated in FIG. 8, the components of FIG. 7 are omitted in FIG. 8.

The first and second display units 461 and 462 may display images including first and second service information, respectively. The first and second service information may be determined based on a signal received from the user device 100 by the edge device 400. The method of determining the first and second service information will be described in more detail in FIG. 11.

The first display unit 461 and a first image including first service information displayed on the first display unit 461 may correspond to the first electrode 411. The second display unit 462 and a second image including second service information displayed on the second display unit 462 may correspond to the second electrode 412. That is, as an example, when the user intends the first service information, the user may select the first service information by touching the first electrode 411.

The first to third electrodes 411 to 413 may be electrodes for the human body communication. The first and second electrodes 41 and 412 may be referred to as select electrodes (selection 1 electrode, selection 2 electrode). The third electrode 413 may be referred to as a start/end electrode. When the user touches the third electrode 413 while simultaneously touching the user device 100, the edge device 200 may transmit the first signal including the identification information, the version information, and the location information of the edge device 200 to the user device 100 through the third electrode 413, the body 10 of the user, and the electrode 110. In addition, the user device 100 may transmit the second signal including the life log information stored in the user device 100 to the edge device 200 through the third electrode 413, the body 10 of the user, and the electrode 110.

The operation processing module 430 in the edge device 400 may generate a plurality of service information, based on the second signal. The edge device 400 may display images including first service information and second service information among the plurality of service information on the first and second display units 461 and 462, respectively.

The user may select the first electrode 411 or the second electrode 412, based on the images displayed on the first and second display units 461 and 462, and the user may touch the selected first electrode 411 or the selected second electrode 412. The edge device 400 may transmit a third signal including the first service information or the second service information corresponding to the first electrode 411 or the selected second electrode 412 that is respectively selected through the first electrode 411 or the second electrode 412 touched by the user to the user device 100.

The number and configuration of the first and second display units 461 and 462, and the first to third electrodes 411 to 413 are not necessarily limited to the form illustrated in FIG. 8, and may be modified according to various embodiments.

FIGS. 9 to 11 are flowcharts describing an operation of a user device communicating in both directions with an edge device of FIG. 7. FIG. 9 is a flowchart illustrating an operation of a user device that stores service information according to a user's direct selection or service information previously selected by the user. FIG. 9 will be described with reference to FIGS. 1, 2, 7, and 8.

Referring to FIG. 9, in operation S210, the user may touch the electrode 410 of the edge device 400 while simultaneously touching the electrode 110 of the user device 100. The edge device 400 may transmit the signal including the identification information, the version information, and the location information of the edge device 400 to the user device 100 through electrodes 110 and 410 and the body 10 of the user. The human body communication module 120 of the user device 100 may receive the signal including the identification information, the location information, the version information, and time information of the edge device 400 from the edge device 400 through the body 10 of the user and the electrodes 110 and 410.

In operation S220, the operation processing module 130, before the signal including the identification information, the location information, the version information, and time information is received, may determine whether the identification information of the edge device 400 is stored in the memory module 140. When the identification information of the edge device 400 is stored in the memory module 140 before the signal including the identification information, the location information, the version information, and time information is received, operation S270 may be performed. When the identification information of the edge device 400 is not stored in the memory module 140 before the signal including the identification information, the location information, the version information, and time information is received, operation S230 may be performed.

In operation S230, the user device 100 may inform the edge device 400 that the identification information of the edge device 400 is not stored. In this case, the human body communication module 120 of the user device 100 may transmit the signal indicating that the identification information of the edge device 400 is not stored to the edge device 400 through the electrodes 110 and 410 and the body 10 of the user.

In operation S240, the edge device 400 may determine whether the user selects a direct selection mode. Here, the direct selection mode may refer to a mode in which the user may directly select desired service information. The voice module 150 of the edge device 400 may output a message asking the user whether to select the direct selection mode as a voice. Alternatively, the display module 160 of the edge device 400 may display a message asking the user whether to select the selection mode directly as an image. When the user selects the direct selection mode, operation S250 may be performed. When the user does not select the direct selection mode, operation S310 of FIG. 10 or operation S410 of FIG. 11 may be performed.

In operation S250, the display module 160 of the edge device 400 may display images including the plurality of service information. The user may select the first service information from among the plurality of service information. As an example, according to the configurations and procedures described in FIG. 8, the edge device 400 may display the images including the plurality of service information, and the user may select the first service information.

The edge device 400 may transmit the signal including the first service information selected by the user to the user device 100 through the electrodes 110 and 410 and the body 10 of the user. The human body communication module 120 of the user device 100 may receive the signal including first service information through the electrodes 110 and 410 and the body 10 of the user.

In operation S260, the user device 100 may store the first service information. Specifically, the operation processing module 130 of the user device 100 may acquire the first service information from the signal including the first service information. The memory module 140 of the user device 100 may store the first service information as part of the life log information.

In operation S270, before a signal including the version information is received, the operation processing module 130 may determine whether the version information of the edge device 400 is stored in the memory module 140. That is, the operation processing module 130 may determine whether current version information of the edge device 400 is the same as the version information of the edge device 400 stored in the memory module 140. When the version information of the edge device 400 is stored in the memory module 140 before the signal including the version information is received (When the current version information of the edge device 400 is the same as the version information of the edge device 400 stored in the memory module 140), operation S280 may be performed. When the version information of the edge device 400 is not stored in the memory module 140 before the signal including the version information is received (When the current version information of the edge device 400 is not the same as the version information of the edge device 400 stored in the memory module 140), operation S310 of FIG. 10 or operation S410 of FIG. 11 may be performed.

In operation S280, the edge device 400 may transmit a signal including the previously selected service information to the user device 100 through the electrodes 110 and 410 and the body 10 of the user. Here, the previously selected service information may comprehensively refer to service information received by touching the edge device 400 in the past. For example, the previously selected service information may be stored in the memory module 440 of the edge device 400. The human body communication module 120 of the user device 100 may receive the signal including previously selected service information through the electrodes 110 and 410 and the body 10 of the user.

In operation S290, the user device 100 may store the previously selected service information. Specifically, the operation processing module 130 of the user device 100 may acquire previously selected service information from the signal including previously selected service information. The memory module 140 of the user device 100 may store the previously selected service information as part of the life log information.

FIG. 10 is a flowchart illustrating an operation of a user device storing service information that is generated based on user's response information to query information according to an embodiment. FIG. 10 will be described with reference to FIGS. 1, 2, 7, 8, and 9.

Referring to FIG. 10, in operation S310, the user device 100 may receive a signal including query information from the edge device 400 through the electrodes 110 and 410 and the body 10 of the user. The signal including the query information may be generated based on the query information that is stored in the memory module 440 by the operation processing module 430 of the edge device 400.

The query information received by the user device 100 may be displayed as an image on the display module 160 of the user device 100 or may be output as a voice to the voice module 150 of the user device 100.

In operation S320, the user device 100 may transmit a signal including the response information that is determined in response to the query information to the edge device 400. The user may provide the response information to the user device 100 in response to the query information that is displayed as an image on the display module 160 of the user device 100 or output as a voice on the voice module 150 of the user device 100. The user may provide the response information to the display module 160 with input by a piezoelectric method or an electrostatic method, or with a voice to the voice module 150. The operation processing module 130 of the user device 100 may generate a signal including the response information. The human body communication module 120 of the user device 100 may transmit the signal including the response information to the edge device 400 through the electrodes 110 and 410 and the body 10 of the user.

In operation S330, the operation processing module 430 of the edge device 400 may generate the service information, based on the signal including the response information. The operation processing module 430 may generate the service information and the signal including the service information based on the response information. The human body communication module 120 of the edge device 400 may transmit the signal including the service information to the user device 100 through the electrodes 110 and 410 and the body 10 of the user. The human body communication module 120 of the user device 100 may receive the signal including the service information that is generated in response to the response information from the edge device 400 through the electrodes 110 and 410 and the body 10 of the user.

In operation S340, the user device 100 may store the service information generated in response to the response information. Specifically, the operation processing module 130 of the user device 100 may acquire the service information that is generated in response to the response information from a signal including the service information generated in response to the response information. The memory module 140 of the user device 100 may store the service information generated in response to the response information as part of the life log information.

FIG. 11 is a flowchart illustrating an operation of a user device that stores first service information selected by a user among a plurality of service information generated based on user's response information to query information according to another embodiment. FIG. 11 will be described with reference to FIGS. 1, 2, 7, 8, and 9.

In FIG. 11, operations S410 and S420 may be substantially the same as operations S310 and S320 of FIG. 10, respectively. Therefore, additional descriptions of operations S410 and S420 will be omitted in the present specification to avoid redundancy.

In operation S430, the operation processing module 430 of the edge device 400 may generate a plurality of service information, based on the signal including the response information. The operation processing module 430 may generate the plurality of service information, based on the response information. The display module 160 of the edge device 400 may display the plurality of service information as images. The user may select first service information from among the plurality of service information, based on the displayed image. Here, the user's selection process may be achieved by the selection process described in FIG. 8. The human body communication module 120 of the edge device 400 may transmit a signal including the first service information selected by the user to the user device 100 through the electrodes 110 and 410 and the body 10 of the user. The human body communication module 120 of the user device 100 may receive a signal including the first service information selected by the user from the edge device 400 through the electrodes 110 and 410 and the body 10 of the user.

In operation S440, the user device 100 may store the first service information selected by the user. Specifically, the operation processing module 130 of the user device 100 may acquire the first service information selected by the user from the signal including the first service information selected by the user. The memory module 140 of the user device 100 may store the first service information selected by the user as part of the life log information.

FIG. 12 is a diagram illustrating query information of FIGS. 8 and 9, according to an embodiment of the inventive concept. FIG. 13 is a diagram illustrating response information of a user to query information of FIG. 12. FIGS. 12 and 13 will be described together.

In FIG. 12, query information may be used to select a user's preference associated with foods included in a classification. The selection result of the user's preference (the user's selection result) may be used to generate service information for a dish provided to the user. The classification may include food ingredients such as meat, a milk, peanuts, a crab, a garlic, etc. In FIG. 12, although the query information is illustrated in text, it will be appreciated that the query information within the user device 100 and the edge device 400 may be processed as binary data.

The display module 160 of the user device 100 may convert the query information into an image and may display the image to the user. In FIG. 12, the query information is illustrated as an image including characters, but the voice module 150 of the user device 100 may convert the query information into sound and may output the sound to the user.

In FIG. 13, it is assumed that the user is a vegetarian, is allergic to peanuts and crustaceans, and likes garlic. The selection result corresponding to the response information of FIG. 13 may be based on the user's preference for foods included in a class.

The display module 160 of the user device 100 may receive response information from the user depending on the touch of the piezoelectric method and the electrostatic method. For example, the display module 160 of the user device 100 may display O or X for each classification of the query information to the user, and the user may select O or X according to the touch of the piezoelectric method and the electrostatic method. Alternatively, the voice module 150 of the user device 100 may receive the response information by recording sound from the user. For example, the user may select O or X for each classification of the query information by transferring YES or NO for each classification of query information to the voice module 150 as a sound.

The operation processing module 430 of the edge device 400 may generate a plurality of service information for cooking, based on the user's response information illustrated in FIG. 13. In addition, the display module 460 of the edge device 400 may display a plurality of service information for cooking such that the plurality of service information for cooking may be selected by the user. The selection process by the user may be accomplished based on the description above in FIG. 8.

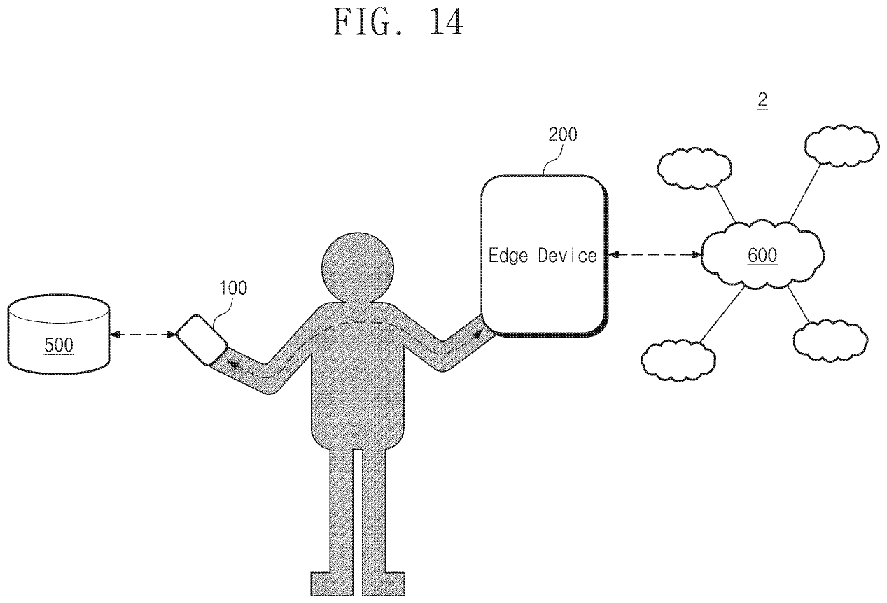

FIG. 14 is a diagram illustrating a human body communication system according to another embodiment of the inventive concept. FIG. 14 will be described with reference to FIGS. 1 and 2. A human body communication system 2 may operate on the same principle as the human body communication system 1 of FIG. 1. That is, the human body communication system 2 may be a system that communicates through the body 10 of the user as a medium. The human body communication system 2 may include the user device 100, the edge device 200, a database 500, and a server 600.

The database 500 may communicate with the user device 100 by wiredly or wirelessly. The database 500 may store information and data received from the user device 100. Also, the database 500 may transmit the stored information and data to the user device 100. The database 500 may store information and data received from the edge device 200 by the user device 100. For example, the database 500 may store the identification information, the version information, the location information of the edge device 200, and time information when a signal is received from the edge device 200. In this case, the database 500 may store the received information and data as the life log information of the user. The database 500 may store and manage the life log information.

Unlike illustrated in FIG. 14, the database 500 may be included in the user device 100. In this case, the database 500 may be connected to the control module 180 in the user device 100 of FIG. 2. The database 500 may receive information and data from respective components in the user device 100 and may store the received information and data. The interlocking method between the database 500 and the user device 100 may be implemented in various ways, and the inventive concept is not specifically limited thereto.

The server 600 may communicate with the edge device 200 by wiredly or wirelessly. The server 600 may store information and data received from the edge device 200. In addition, the server 600 may transmit the stored information and data to the edge device 200. The server 600 may store the identification information, the version information, and the location information of the edge device 200 and may store the query information and the service information. The server 600 may acquire or generate new information for updating each information, and may transmit the new information to the edge device 200.

The server 600 may receive response information determined by the user from the edge device 200 in response to the query information. In this case, the server 600 may analyze the response information and may generate a plurality of service information, based on the analysis result or may acquire the plurality of service information from the outside. That is, the server 600 may generate the plurality of service information in response to the response information. Alternatively, the server 600 may select at least one service information among the plurality of service information, based on the response information, and may transmit the selected at least one service information to the edge device 200. The interlocking method between the server 600 and the edge device 200 may be variously implemented, and the inventive concept is not specifically limited thereto.

A user device according to the inventive concept may collect life log information generated from a user's intuitive touch by using a touch-based human body communication method.

An edge device according to the inventive concept may improve a quality of human life and may provide a human-centered life assistant service, by providing user-friendly customized services, based on the collected user's life log information

The contents described above are specific embodiments for implementing the inventive concept. The inventive concept may include not only the embodiments described above but also embodiments in which a design is simply or easily capable of being changed. In addition, the inventive concept may also include technologies easily changed to be implemented using embodiments.

What is claimed is:

1. A user device connected to an edge device, based on a touch of a user, the user device comprising:
an electrode in touch with a body of the user;
a human body communication module configured to receive a first signal from the edge device through the body and the electrode;
an operation processing module configured to acquire identification information, location information, version information of the edge device, and time information at which the first signal is received, from the first signal; and
a memory module configured to store the identification information, the location information, the version information, and the time information, as part of life log information.

2. The user device of claim 1, wherein the operation processing module determines whether the identification information is stored in the memory module before the human body communication module receives the first signal.

3. The user device of claim 2, wherein, when the identification information is stored in the memory module before the human body communication module receives the first signal, the operation processing module determines whether the version information is stored in the memory module before the human body communication module receives the first signal.

4. The user device of claim 3, wherein, when the version information is stored in the memory module before the human body communication module receives the first signal,
the human body communication module receives a second signal including first service information that is previously selected by the user from the edge device through the body of the user and the electrode,
the operation processing module acquires the first service information from the second signal, and
the memory module stores the first service information as another part of the life log information.

5. The user device of claim 3, wherein, when the version information is not stored in the memory module before the human body communication module receives the first signal, the human body communication module receives a third signal including query information from the edge device through the body of the user and the electrode.

6. The user device of claim 5, wherein the human body communication module transmits a fourth signal including response information that is determined in response to the query information by the user to the edge device through the electrode and the body of the user.

7. The user device of claim 6, wherein the human body communication module receives a fifth signal including second service information generated in response to the response information from the edge device through the body of the user and the electrode,
the operation processing module acquires the second service information from the fifth signal, and
the memory module stores the second service information as another part of the life log information.

8. An edge device connected to a user device, based on a touch of a user, the edge device comprising:
an electrode in touch with a body of the user;
an operation processing module configured to generate a first signal including identification information, version information, and location information; and
a human body communication module configured to transmit the first signal to the user device through the electrode and the body, and to receive a second signal including life log information stored in the user device from the user device through the body and the electrode, and
wherein the operation processing module generates a plurality of service information, based on the second signal.

9. The edge device of claim 8, wherein the operation processing module determines whether the identification information is included in the life log information.

10. The edge device of claim 9, wherein, when the identification information is not included in the life log information, the human body communication module transmits a third signal including query information to the user device through the electrode and the body of the user.

11. The edge device of claim 8, further comprising:
a display module configured to display the plurality of the service information.

12. The edge device of claim 11, wherein the human body communication module is configured to transmit a fourth signal including first service information selected by the user from among the plurality of service information to the user device through the electrode and the body of the user.

13. A human body communication system to communicate using a body of a user as a medium comprising:
an edge device configured to generate a first signal including identification information, location information, and version information; and
a user device configured to receive the first signal through the body of the user, to acquire the identification information, the location information, the version information, and time information at which the first signal is received, from the first signal, and to store the identification information, the location information, the version information, and the time information, as part of life log information.

14. The human body communication system of claim 13, wherein the user device includes:
a memory module configured to store the life log information; and
an operation processing module configured to determine whether the identification information is stored in the memory module before the first signal is received.

15. The human body communication system of claim 14, wherein the edge device includes a display module, and
wherein, when the identification information is not included in the memory module before the first signal is received, the display module displays images including a plurality of service information.

16. The human body communication system of claim 15, wherein the edge device further includes an operation processing module configured to generate a second signal including first service information selected by the user among the plurality of service information.

17. The human body communication system of claim 14, wherein, when the identification information is stored in the memory module before the first signal is received,
the edge device transmits a third signal including query information to the user device through the body of the user, and
the user device transmits a fourth signal including response information that is determined in response to the query information to the edge device through the body.

18. The human body communication system of claim 17, wherein the edge device transmits a fifth signal including a plurality of service information generated in response to the response information to the user device through the body of the user.

19. The human body communication system of claim 18, further comprising:
a server configured to generate the plurality of service information in response to the response information.

20. The human body communication system of claim 13, further comprising:
a database configured to store and manage the life log information.
